(19) United States
(12) Patent Application Publication
(10) Pub. No.: US 2026/0364612 A1
(43) Pub. Date: Nov. 19, 2026

(54) SAMPLE SORTING STRUCTURE, SAMPLE SORTING METHOD AND RELATED DEVICE

(71) Applicant: BGI SHENZHEN, Shenzhen (CN)

(72) Inventors: Zongfa MENG, Shenzhen (CN); Lihao ZHU, Shenzhen (CN); Pengfei ZHA, Shenzhen (CN); Jie LUO, Shenzhen (CN); Dong CAI, Shenzhen (CN); Yan HONG, Shenzhen (CN); Mengzhe SHEN, Shenzhen (CN); Yuxiang LI, Shenzhen (CN); Ao CHEN, Shenzhen (CN); Wenwei ZHANG, Shenzhen (CN); Xun XU, Shenzhen (CN)

(21) Appl. No.: 19/145,816

(22) PCT Filed: Jan. 3, 2023
(86) PCT No.: PCT/CN2023/070052

§ 371 Date: Jul. 3, 2025

(51) Int. Cl. B04B 5/04; G01N 1/40

(52) U.S. Cl. CPC B04B 5/0428; B04B 5/0442; G01N 1/4077; G01N 2001/4083

(57) ABSTRACT

A sample sorting structure includes: a centrifugal chamber assembly having a centrifugal inner cavity; a rotation driving assembly for driving the centrifugal chamber assembly to rotate; a spindle being synchronously rotatably connected to the centrifugal chamber assembly, one end of the spindle extending to the centrifugal inner cavity and being movable relative to the centrifugal inner cavity; an extrusion platform fixed at the end of the spindle extending to the centrifugal inner cavity and used for loading a sample bag to be sorted, and driven by the spindle to move close to or away from the end of the centrifugal inner cavity used for extruding the sample bag to be sorted; and a horizontal pushing driving assembly for driving the spindle to move in the centrifugal inner cavity, the horizontal pushing driving assembly being rotatably connected to the spindle.

### FIELD

The present application relates to the technical field of sample sorting and, in particular, to a sample sorting structure, a sorting device, a sample sorting fluid system, a sample cultivation system, and a sample sorting method.

### BACKGROUND

At present, a centrifugal structure is commonly used for sorting of samples such as cells. The samples are placed in a centrifuge for centrifugation and are then sorted. In the conventional technology, centrifugation and sorting are usually carried out separately, resulting in low sorting efficiency. The desired target cells may be mixed with other cells, thereby reducing the effectiveness of detection and treatment. Moreover, the entire process requires manual intervention and cannot be automated, incurring high labor costs.

Furthermore, it is known a sorting device that performs sorting while centrifuging. However, the samples cannot be completely discharged out of a centrifugal chamber by centrifugal force alone, resulting in a high residual amount of samples. Thus, the centrifuged samples still need to be pumped through pipelines into different containers by a pump. In this case, such a centrifugal chamber has a complex structure. Additionally, the centrifugal chamber, as consumable item, is relatively expensive.

In summary, it is desired for those skilled in the art to improve the efficiency of sample sorting, enhance sample utilization, and reduce costs.

### SUMMARY

A sample sorting structure, a sorting device, a sample sorting fluid system, a sample cultivation system, and a sample sorting method are provided according to the present application, so as to improve sample sorting efficiency, increase sample utilization and reduce costs.

In order to realize the above objects, the following technical solutions are provided according to the present application.

In a first aspect, a sample sorting structure is provided according to the present application, including:

a centrifugal chamber assembly, which has a centrifugal inner cavity;

a rotation driving assembly for driving the centrifugal chamber assembly to rotate;

a spindle connected to the centrifugal chamber assembly in such a manner as to rotate synchronously, wherein one end of the spindle extends into the centrifugal inner cavity and is movable relative to the centrifugal inner cavity;

a pressing platform fixed at the end of the spindle extending into the centrifugal inner cavity, wherein the pressing platform is configured to load a sample bag to be sorted and be moved by the spindle towards or away from a side of the centrifugal inner cavity for pressing the sample bag to be sorted; and

a translation driving assembly for driving the spindle to move in the centrifugal inner cavity, the translation driving assembly being rotatably connected to the spindle.

In some possible embodiments of the present application, the side of the centrifugal inner cavity for pressing the sample bag to be sorted is arranged in parallel to the side of the pressing platform for loading the sample bag to be sorted.

In some possible embodiments of the present application, the centrifugal chamber assembly includes:

a centrifugal chamber, an inner cavity of the centrifugal chamber being the centrifugal inner cavity; and

a shaft sleeve mounted on the centrifugal chamber, wherein the rotation driving assembly is in transmission connection with the shaft sleeve; the spindle is disposed in the shaft sleeve, and has one end extending out of the shaft sleeve and entering the centrifugal inner cavity, and the other end extending out of the shaft sleeve and being in transmission connection with the translation driving assembly.

In some possible embodiments of the present application, the shaft sleeve is connected to the spindle by splines or a key.

In some possible embodiments of the present application, the centrifugal chamber includes a centrifugal chamber housing and a centrifugal chamber cover;

the centrifugal chamber housing has an opening at an end, and the centrifugal chamber cover is detachably provided at and covers the opening of the centrifugal chamber housing; and

the shaft sleeve is fixed to the end of the centrifugal chamber housing opposite to the opening.

In some possible embodiments of the present application, a rotation-limiting projection is provided on an edge of the centrifugal chamber cover, and a rotation-limiting notch is provided on a top end of the centrifugal chamber housing and configured to limit the rotation-limiting projection; and/or

the centrifugal chamber cover and the centrifugal chamber housing have surfaces facing each other; one of the surfaces is provided with a connecting column; the connecting column is provided with a fastening hole on an end surface facing the other of the surfaces; the other of the surfaces is detachably connected to the connecting column through a fastener; and a through hole is provided in the pressing platform to allow passage of the connecting column; or

the centrifugal chamber cover and the centrifugal chamber housing are each provided with a connecting hole, and detachably connected to each other by a fastener; and a through hole is provided in the pressing platform to allow passage of the fastener.

In some possible embodiments of the present application, the centrifugal chamber assembly further includes a rotary joint, which is mounted on the centrifugal chamber cover; and the rotary joint has one end connected to an outlet of the sample bag to be sorted and the other end externally connected to an output pipeline.

In some possible embodiments of the present application, the centrifugal chamber assembly further includes a joint fixing member and a centrifuge rubber block;

the centrifuge rubber block is inserted into a rubber-block fixing through-hole provided in the centrifugal chamber cover, and the centrifuge rubber block is provided with a mounting hole for mounting one end of the rotary joint, with the sample bag to be sorted in the centrifugal chamber being connected to the rotary joint; and

the joint fixing member is fixed, and the other end of the rotary joint is mounted to the joint fixing member and extends out of the joint fixing member to be externally connected to the output pipeline.

In some possible embodiments of the present application, the centrifugal chamber assembly further includes a protective cover;

the protective cover is fixed and located above the centrifugal chamber; and

the joint fixing member is mounted on the top of the protective cover.

In some possible embodiments of the present application, the protective cover is made of transparent material; and/or

a handle is provided on the top of the protective cover.

In some possible embodiments of the present application, at least part of a cross section of the pressing platform gradually decreases in thickness in a direction from an end away from the spindle to an end close to the spindle; or

the pressing platform includes a first turntable supporting the sample bag to be sorted and a second turntable connected to the spindle, wherein the second turntable is connected to a bottom of the first turntable, and reinforcement ribs are provided between the first turntable and the second turntable; and/or

the spindle is provided with a connecting disc connected to the pressing platform.

In some possible embodiments of the present application, the rotation driving assembly includes:

a first mounting seat provided with a mounting hole for allowing the shaft sleeve to pass through;

a bearing seat mounted on the first mounting seat;

a bearing set mounted in the bearing seat, with the shaft sleeve being disposed in the bearing set;

a first driver mounted on the first mounting seat; and

a first transmission mechanism in transmission connection with the first driver and the shaft sleeve.

In some possible embodiments of the present application, the first driver is a first motor, or the first driver includes a first motor and a first speed reducer in transmission connection with the first motor; and/or

the first transmission mechanism is a transmission belt mechanism, a transmission gear mechanism or a conveyor chain mechanism; and/or

the first transmission mechanism and the bearing seat are respectively mounted at two sides of the first mounting seat.

In some possible embodiments of the present application, the rotation driving assembly further includes a first spacer, a second spacer, and a locking member;

the bearing set includes a first bearing and a second bearing;

an outer wall of the shaft sleeve is provided with a first limiting step; an end of an inner ring of the first bearing facing the centrifugal chamber abuts against the first limiting step; and the first spacer is arranged outside the shaft sleeve; and an end of the first spacer facing the centrifugal chamber abuts against an end of the inner ring of the first bearing facing away from the centrifugal chamber;

an inner wall of the bearing seat is provided with a limiting protrusion, and an end of an outer ring of the first bearing facing away from the centrifugal chamber abuts against an end of the limiting protrusion facing the centrifugal chamber; and

an end of the inner ring of the second bearing facing the centrifugal chamber abuts against an end of the first spacer facing away from the centrifugal chamber; an end of the outer ring of the second bearing facing the centrifugal chamber abuts against an end of the limiting protrusion facing away from the centrifugal chamber; the second spacer is arranged outside the shaft sleeve, and an end of the second spacer facing the centrifugal chamber abuts against an end of the inner ring of the second bearing facing away from the centrifugal chamber; and the locking member is locked onto the shaft sleeve, and an end of the locking member facing the centrifugal chamber abuts against an end of the second spacer facing away from the centrifugal chamber.

In some possible embodiments of the present application, the translation driving assembly includes: a second mounting seat; a second driver mounted on the second mounting seat; and a second transmission mechanism, which has one end in transmission connection with the second driver, and the other end in transmission connection with an end of the spindle away from the centrifugal chamber assembly, so as to be driven by the second driver and move the spindle in the centrifugal inner cavity; or

the translation driving assembly includes: a second mounting seat; and a linear electric cylinder, a pneumatic cylinder, a hydraulic cylinder, or an electric push rod mounted on the second mounting seat and having a driving end rotatably connected to the spindle.

In some possible embodiments of the present application, the second transmission mechanism is a rocker slider mechanism, which includes a rocker arm, a connecting rod, a bearing chamber, and a third bearing,

one end of the rocker arm is in transmission connection with the second driver; the other end of the rocker arm is hinged to one end of the connecting rod; the other end of the connecting rod is hinged to the bearing chamber; the third bearing is mounted in the bearing chamber; and the end of the spindle away from the centrifugal chamber assembly is rotatably connected to the third bearing,

a rotation axis of the rocker arm is perpendicular to a direction of movement of the spindle in the centrifugal inner cavity.

Alternatively, the second transmission mechanism is a screw-and-nut mechanism, and the spindle is rotatably connected to the nut of the screw-and-nut mechanism.

In some possible embodiments of the present application, the rocker sliding mechanism further includes a first joint bearing and a second joint bearing;

one end of the first joint bearing is threadedly connected to one end of the connecting rod, and the other end of the first joint bearing is hinged to the third bearing seat; and

one end of the second joint bearing is threadedly connected to the other end of the connecting rod, and the other end of the second joint bearing is hinged to the rocker arm.

In some possible embodiments of the present application, the second driver includes a second motor, a transmission shaft, and a fourth bearing; and

the second motor is mounted on the second mounting seat and is in transmission connection with the transmission shaft; the transmission shaft is rotatably mounted on the second mounting seat through the fourth bearing; and the rocker arm is fixed on the transmission shaft.

In some possible embodiments of the present application, the translation driving assembly further includes a limiting sensor; and

the limiting sensor is mounted on the second mounting seat and configured to detect a rotation angle of the transmission shaft.

In a second aspect, a sorting device is provided according to the present application, including a base frame, a control device, and the sample sorting structure according to any one of the above embodiments; and

the sample sorting structure and the control device are both mounted on the base frame, and the control device is in signal connection with the sample sorting structure.

In a third aspect, a sample sorting fluid system is provided according to the present application, including an output pipeline, sorting containers, and the sample sorting structure according to any one of the above embodiments; and

the outlet of a sample bag to be sorted within the sample sorting structure is connected to the inlet of the output pipeline through a rotary joint, and the outlets of the output pipeline are respectively connected to the corresponding sorting containers.

In a fourth aspect, a sample cultivation system is provided according to the present application, including an output pipeline, sample cultivation vessels, and the sample sorting structure according to any one of the above embodiments; and

the outlet of a sample bag to be sorted within the sample sorting structure is connected to the inlet of the output pipeline through a rotary joint, and the outlets of the output pipeline are respectively connected to the corresponding sample cultivation vessels.

In a fifth aspect, a sample sorting method is provided according to the present application, including the following steps:

providing the sample sorting structure according to any one the above embodiments;

placing a sample bag to be sorted on the pressing platform in the centrifugal inner cavity;

activating the rotation driving assembly to drive the centrifugal chamber assembly and the spindle to rotate synchronously, thereby rotating the sample bag to be sorted for sample stratification; and

activating the translation driving assembly to drive the spindle to move towards the side of the centrifugal inner cavity for pressing the sample bag to be sorted, thereby pressing the sample bag to be sorted to squeeze the stratified samples therein into corresponding sorting containers.

As can be seen from the above technical solutions: a sample sorting structure is provided according to the present application. During use, a sample bag to be sorted is placed in a centrifugal inner cavity and loaded on a pressing platform. The rotation driving assembly is activated to drive a spindle and a centrifugal chamber assembly to rotate synchronously, thereby rotating the pressing platform. The blood in the sample bag to be sorted undergoes sample stratification under the action of centrifugal force. The translation driving assembly is activated to push the pressing platform and the sample bag to be sorted toward the side of the centrifugal inner cavity for pressing the sample bag to be sorted, so that the different sample layers in the sample bag to be sorted can be squeezed into corresponding containers respectively, thereby achieving the separation of the target sample. The present application adopts an automated method for simultaneous centrifugation and squeezing separation, which improves sample separation efficiency, facilitates complete discharge of the sample, enhances sample utilization rate, and reduces costs.

### BRIEF DESCRIPTION OF THE DRAWINGS

In order to more clearly illustrate technical solutions in embodiments of the present application or in the conventional technology, the drawings to be used in the description of the embodiments or the conventional technology are briefly described below. Apparently, the drawings in the following description show only some embodiments of the present application, and other drawings may be obtained by those skilled in the art from the drawings without any creative work. In addition, the present application may be further applied to other similar scenarios based on the drawings. The same reference numerals in the drawings represent the same structure or operation unless it is obvious from the language context or otherwise stated.

FIG. 1 is a schematic perspective structural view of a sample sorting structure provided according to an embodiment of the present application;

FIG. 2 is a schematic front structural view of a sample sorting structure provided according to an embodiment of the present application;

FIG. 3 is a schematic sectional structural view taken along line A-A in FIG. 2;

FIG. 4 is a schematic structural view of a part of FIG. 2;

FIG. 5 is a schematic structural view of another part of FIG. 2;

FIG. 6 is a schematic front structural view of a sample sorting structure provided according to another embodiment of the present application;

FIG. 7 is a schematic sectional structural view taken along line B-B in FIG. 6;

FIG. 8 is a schematic front structural view of a sample sorting structure provided according to yet another embodiment of the present application;

FIG. 9 is a schematic sectional structural view taken along line C-C in FIG. 8;

FIG. 10 is a schematic perspective structural view of a centrifugal chamber provided according to an embodiment of the present application;

FIG. 11 is a schematic perspective structural view of a centrifugal chamber cover provided according to an embodiment of the present application;

FIG. 12 is a schematic perspective structural view of a pressing platform provided according to an embodiment of the present application, viewing from a direction;

FIG. 13 is a schematic perspective structural view of a pressing platform provided according to an embodiment of the present application, viewing from another direction;

FIG. 14 is a schematic perspective structural view of a pressing platform provided according to another embodiment of the present application;

FIG. 15 is a schematic perspective structural view of a spindle provided according to an embodiment of the present application; and

FIG. 16 is a schematic perspective structural view of a sorting device provided according to an embodiment of the present application.

List of reference numerals:

100 sample sorting structure, 101b centrifugal chamber, 101 centrifugal chamber assembly, 101b-1 centrifugal chamber housing, 101b-2 centrifugal chamber cover, 101a centrifugal inner cavity, 102 rotation driving assembly, 103 spindle, 104 pressing platform, 105 translation driving assembly, 101c shaft sleeve, 101d rotary joint, 101f centrifugal rubber block, 101e joint fixing member, 101g protective cover, 101g-1 handle, 103a spline, 101b-2a rotation-limiting projection, 101b-1a rotation-limiting notch, 101b-2b connecting column, 104a through hole, 104b accommodation groove, 104c first turntable, 104d second turntable, 104e reinforcement rib, 103b connecting disc, 102a first mounting seat, 102b bearing seat, 102c bearing set, 102d first driver, 102e first transmission mechanism, 101e-1 driving pulley, 101e-2 driven pulley, 101e-3 transmission belt, 102f first spacer, 102g second spacer, 102h locking member, 102c-1 first bearing, 102c-2 second bearing, 101c-1 first limiting step, 102b-1 limiting protrusion, 105a second mounting seat, 105b second driver, 105c second transmission mechanism, 105c-1 rocker arm, 105c-2 connecting rod, 105c-3 bearing chamber, 105c-4 third bearing, 105c-3a first limiting boss, 105c-3b bearing chamber cover, 105c-3b-1 limiting ring, 105c-5 first joint bearing, 105c-6 second joint bearing, 105b-1 second motor, 105b-2 transmission shaft, 105b-3 fourth bearing, 105b-4 limiting sensor, 105b-5 second speed reducer, 103c detection groove, 103d second limiting boss, 1000 sorting device, 200 base frame, 300 control device, 201 frame body, 202 mounting panel, 105d linear electric cylinder.

### DETAILED DESCRIPTION OF THE EMBODIMENTS

Hereinafter, the present application will be further described in detail with reference to the accompanying drawings by means of embodiments. It is can be understood that specific embodiments described herein are used to simply explain related parts of the present application, but not to limit the present application. The embodiments described below are only some embodiments rather than all the embodiments of the present application. Based on the embodiments of the present application, all other embodiments obtained by those skilled in the art without any creative work fall into the protection scope of the present application.

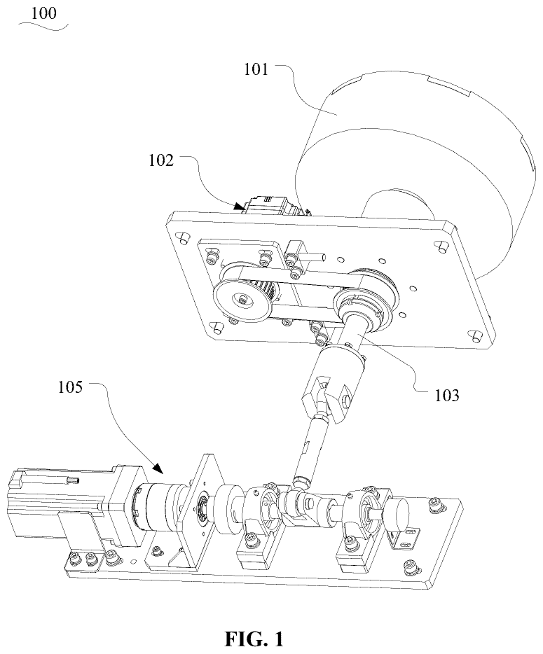

As shown in FIGS. 1 to 15, a sample sorting structure 100 provided according to an embodiment of the present application adopts a method of performing centrifugation and pressing simultaneously to achieving sample stratification and sorting on a sample bag to be sorted, thereby improving sorting efficiency and reducing labor costs.

As shown in FIGS. 1 to 9, the sample sorting structure 100 includes a centrifugal chamber assembly 101, a rotation driving assembly 102, a spindle 103, a pressing platform 104, and a translation driving assembly 105.

The centrifugal chamber assembly 101 has a centrifugal inner cavity 101a that provides a space for placing the sample bag to be sorted. For example, the centrifugal inner cavity 101a is annular to achieve uniform sample stratification. Alternatively, the centrifugal inner cavity 101a may be in any other shape. The sample bag to be sorted is a disposable plastic film product, which is inexpensive and used for storing samples such as blood.

The rotation driving assembly 102 drives the centrifugal chamber assembly 101 to rotate, thereby causing the sample bag to be sorted to perform centrifugal motion.

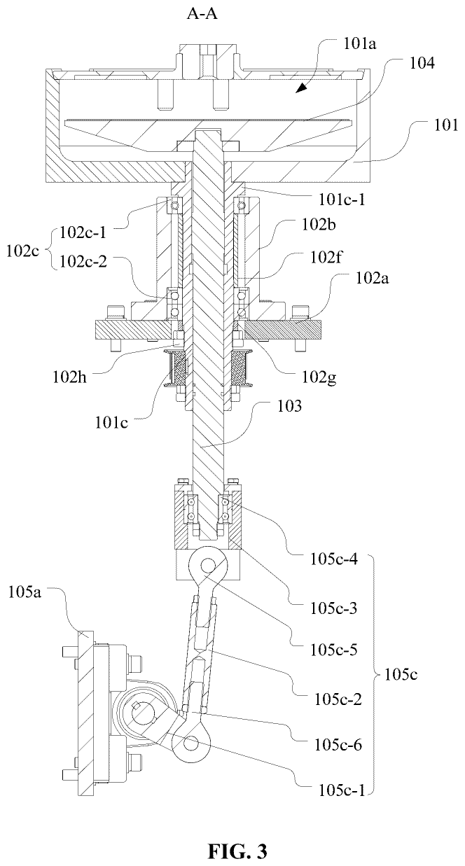

The spindle 103 is connected to the centrifugal chamber assembly 101 in such a manner as to rotate synchronously, and has an end extending into the centrifugal inner cavity 101a as shown in FIGS. 3, 7, and 9 and being movable relative to the centrifugal inner cavity 101a. Specifically, a rotational axis of the spindle 103 coincides with a rotational axis of the centrifugal inner cavity 101a, meaning that the spindle 103 and the centrifugal inner cavity 101a can rotate synchronously. The spindle 103 further can move along the rotational axis of the centrifugal inner cavity 101a.

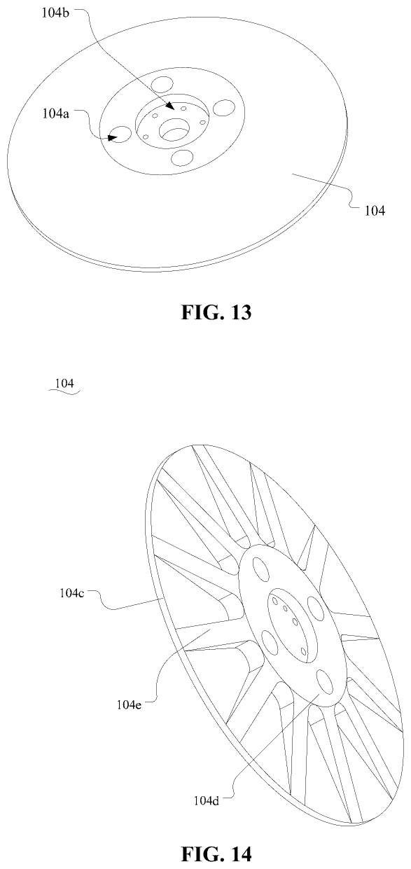

The pressing platform 104 is located within the centrifugal inner cavity 101a and is fixed to the end of the spindle 103 that extends into the centrifugal inner cavity 101a. Specifically, for easy assembly and disassembly of the pressing platform 104 and the spindle 103, the spindle 103 is provided with a connecting disc 103b, which is provided with through holes for connecting the spindle 103 to the pressing platform 104 by fasteners. To facilitate positioning of the pressing platform 104 to be coaxially aligned with the spindle 103, the pressing platform 104 is provided with a receiving groove 104b for receiving the spindle 103. The shape of the pressing platform 104 matches with the shape of the connecting disc 103b, as shown in FIG. 13.

To reduce the weight of the pressing platform 104, its cross section in a direction from its end face facing away from the spindle 103 to its end face facing the spindle 103 is at least partially reduced, as shown in FIG. 13.

As shown in FIG. 14, the pressing platform 104 may be configured to include a first turntable 104c for supporting the sample bag to be sorted and a second turntable 104d connected to the spindle 103. The second turntable 104d is connected to the bottom of the first turntable 104c, and reinforcing ribs 104e are provided between the first turntable 104c and the second turntable 104d.

The pressing platform 104 is used to load the sample bag to be sorted and is driven by the spindle 103 to move towards or away from the side of the centrifugal inner cavity 101a for pressing the sample bag to be sorted. To completely squeeze the samples out of the sample bag to be sorted, a loading surface of the pressing platform 104 for loading the sample bag to be sorted and a pressing surface of the centrifugal inner cavity 101a for pressing against the sample bag to be sorted may be arranged to be parallel to each other. Specifically, both of the loading surface and the pressing surface may be flat, or conical, or in any other shape allowing these surfaces to be parallel to each other, which fall within the protection scope of the present application.

The translation driving assembly 105 drives the spindle 103 to move along the rotational axis of the centrifugal inner cavity 101a within the centrifugal inner cavity 101a. The translation driving assembly 105 is rotatably connected to the spindle 103, thereby avoiding any interference with the rotation of the spindle 103 during its translation movement.

The present application adopts a method of simultaneous centrifugation and squeezing. Centrifugation can separate samples, separating the target sample from the rest of the samples. The translation driving assembly 105 translates the spindle 103, ensuring that the pressing platform 104 presses fully against the surface of the centrifugal inner cavity 101a for pressing the sample bag to be sorted. As a result, the sample within the sample bag can be squeezed out completely, allowing for full collection of the target sample and reducing the possibility that detection and treatment could not meet the requirement due to the loss of the target sample.

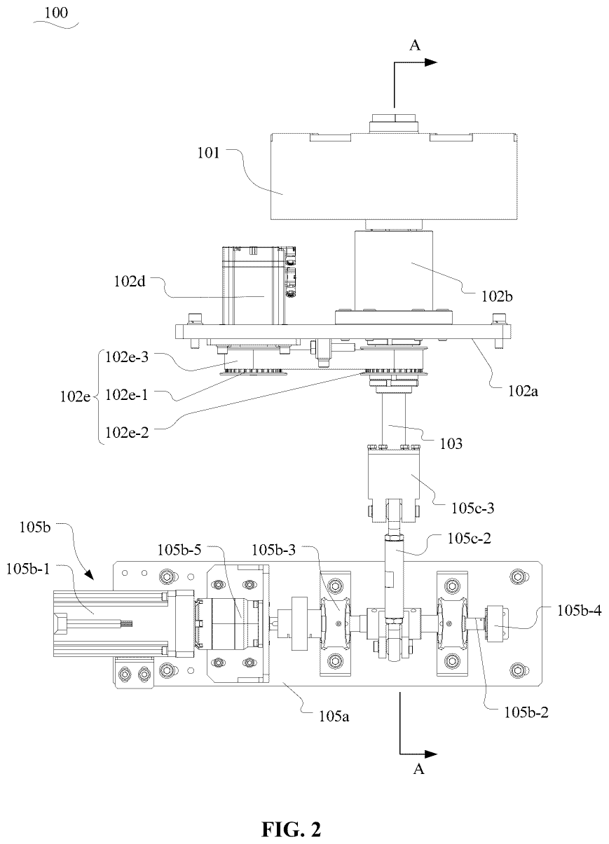

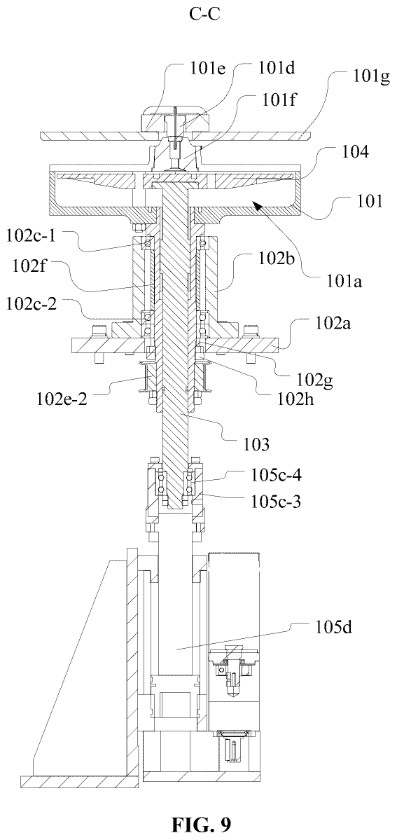

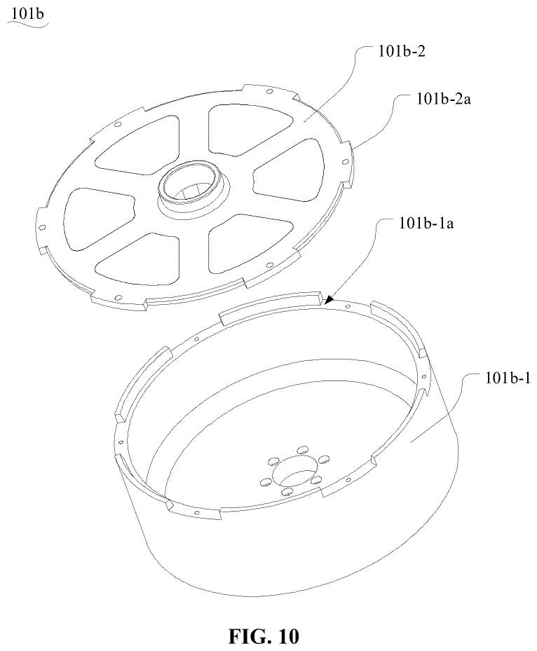

In some embodiments, the centrifugal chamber assembly 101 includes a centrifugal chamber 101b, and an inner cavity of the centrifugal chamber 101b is the centrifugal inner cavity 101a. Specifically, as shown in FIG. 10, the centrifugal chamber 101b includes a centrifugal chamber housing 101b-1 and a centrifugal chamber cover 101b-2. The centrifugal chamber housing 101b-1 has an opening at one end. For ease of description, based on the orientation in FIG. 2, the centrifugal chamber housing 101b-1 has an opening at its top end, and the centrifugal chamber cover 101b-2 is provided at and covers the opening of the centrifugal chamber housing 101b-1. The surface of the centrifugal chamber cover 101b-2 facing the centrifugal chamber housing 101b-1 serves as the pressing surface of the centrifugal inner cavity 101a for pressing the sample bag to be sorted.

To observe the sorting process of the sample bag to be sorted within the centrifugal chamber 101b, at least part of the centrifugal chamber cover 101b-2 is made of transparent material, and the other part(s) may be made of materials such as aluminum, balancing strength with weight reduction of the centrifugal chamber cover 101b-2.

To facilitate loading or unloading the sample bag to be sorted, the centrifugal chamber cover 101b-2 may be detachably connected to the centrifugal chamber housing 101b-1. Specifically, the centrifugal chamber cover 101b-2 may be detachably fixed to the centrifugal chamber housing 101b-1 by fasteners such as screws; or the centrifugal chamber cover 101b-2 may be hinged to the centrifugal chamber housing 101b-1 on one side and connected to the centrifugal chamber housing 101b-1 on the other side in any other manner such as snap-fit.

As shown in FIG. 10, rotation-limiting projections 101b-2a are arranged on an edge of the centrifugal chamber cover 101b-2, and rotation-limiting notches 101b-1a for limiting the rotation-limiting projections 101b-2a are provided on the top end of the centrifugal chamber housing 101b-1, so as to achieve stable connection between the centrifugal chamber cover 101b-2 and the centrifugal chamber housing 101b-1. Specifically, the number of the rotation-limiting projections 101b-2a is more than one, and the multiple rotation-limiting projections 101b-2a are evenly distributed along a circumferential direction of the centrifugal chamber cover 101b-2. Correspondingly, the multiple rotation-limiting notches 101b-1a are evenly distributed on the top end of the centrifugal chamber housing 101b-1. The rotation-limiting notches 101b-1a are in one-to-one correspondence with the rotation-limiting projections 101b-2a.

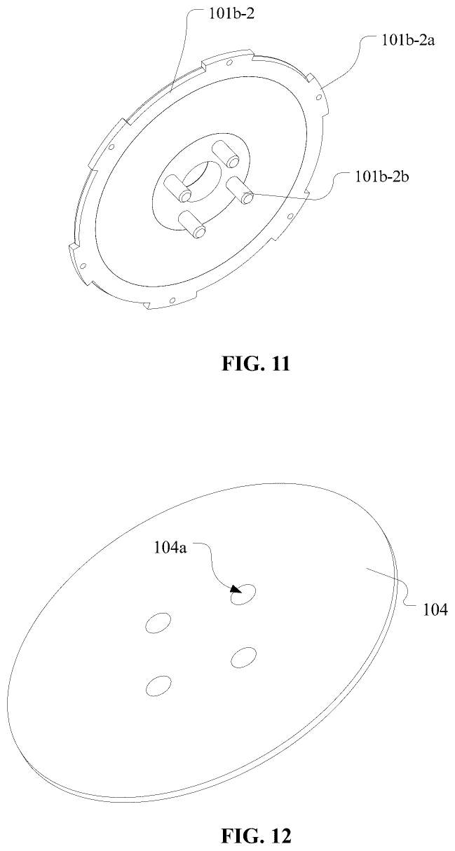

To facilitate the connection between the centrifugal chamber cover and the centrifugal chamber housing, one of surfaces of the centrifugal chamber cover 101b-2 and the centrifugal chamber housing 101b-1 that face each other is provided with a connecting column 101b-2b, with a fastening hole opened on an end surface of the connecting column 101b-2b facing the other of the surfaces of the centrifugal chamber cover 101b-2 and the centrifugal chamber housing 101b-1 that face each other. The other of the surfaces of the centrifugal chamber cover 101b-2 and the centrifugal chamber housing 101b-1 that face each other is detachably connected to the connecting column 101b-2b by fasteners. A through hole 104a for passage of the connecting column 101b-2b is provided in the pressing platform 104, as shown in FIG. 12. For example, the connecting column 101b-2b is mounted on the centrifugal chamber cover 101b-2, as shown in FIG. 11.

To facilitate the rotation of the sample bag to be sorted together with the centrifugal chamber 101b, a limiting hole for passage of the connecting column 101b-2b is provided in the sample bag to be sorted. The connecting column 101b-2b passes through the limiting hole in the sample bag to be sorted, enabling the sample bag to be sorted to rotate together with the centrifugal chamber 101b.

It should be noted that the connecting column 101b-2b may be omitted. In this case, both the centrifugal chamber cover 101b-2 and the centrifugal chamber housing 101b-1 may be provided with through holes, and detachably connected to each other by a bolt or any other fastener. The pressing platform 104 is provided with a through hole 104a for passage of the fastener, and the fastener may also pass through the limiting hole in the sample bag to be sorted.

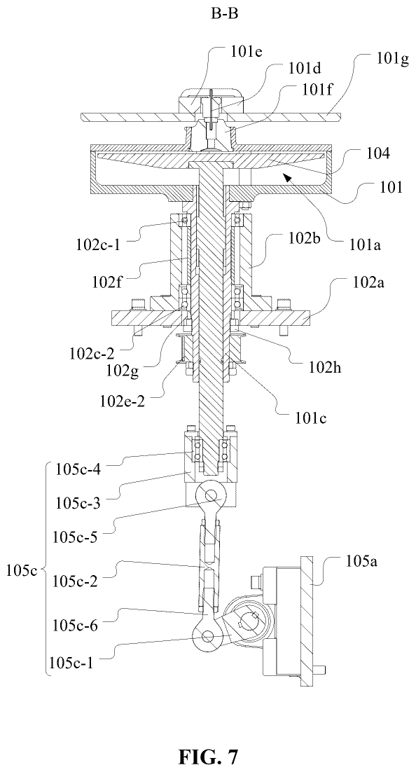

In some embodiments, to facilitate the output of the sample from the sample bag to be sorted, the centrifugal chamber 101b further includes a rotary joint 101d, as shown in FIGS. 7 and 9. The rotary joint 101d is mounted on the centrifugal chamber cover 101b-2, and has an end connected to an outlet of the sample bag to be sorted and the other end for external connection to an output pipeline.

As shown in FIGS. 7 and 9, the centrifugal chamber assembly 101 further includes a joint fixing member 101e and a centrifuge rubber block 101f. The centrifuge rubber block 101f is inserted into a rubber-block fixing through-hole provided in the centrifugal chamber cover 101b-2, and the centrifuge rubber block 101f is provided with a mounting hole for mounting one end of the rotary joint 101d. The centrifuge rubber block 101f facilitates achieving a sealed connection with the centrifugal chamber cover 101b-2. Specifically, the centrifuge rubber block 101f is coaxial with the centrifugal chamber 101b.

The sample bag to be sorted in the centrifugal chamber 101b is connected to the rotary joint 101d to realize the output of the sample from the sample bag to be sorted.

The joint fixing member 101e remains stationary, and the other end of the rotary joint 101d is mounted on the joint fixing member 101e and extends out of the joint fixing member 101e for external connection to an output pipeline.

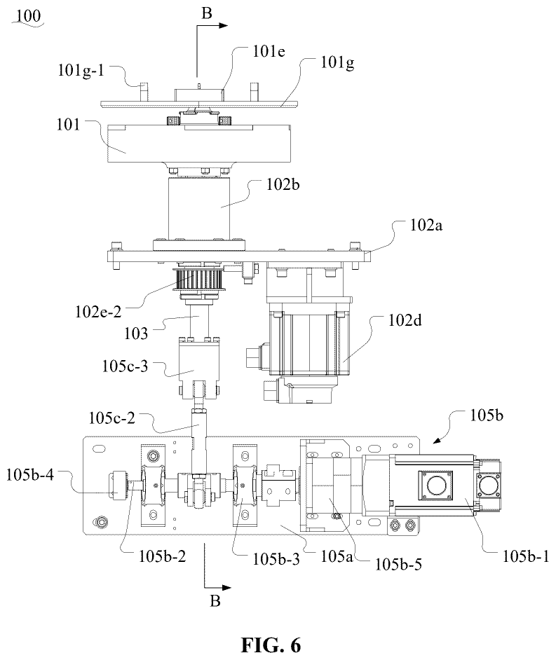

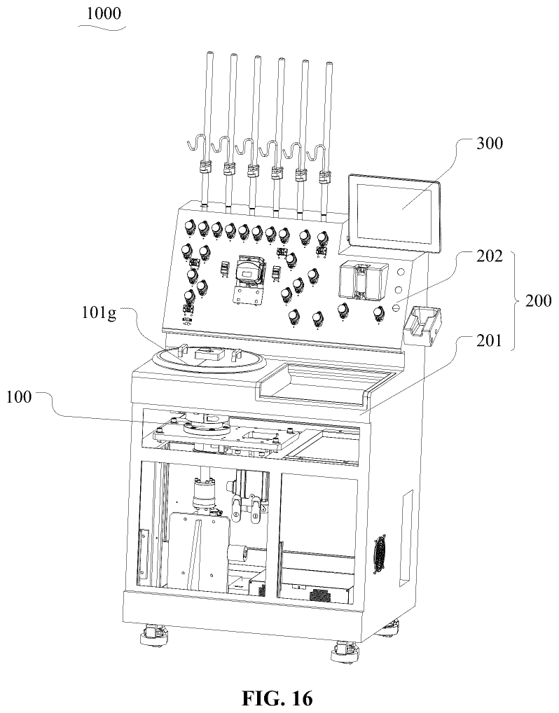

As shown in FIGS. 6 to 9, the centrifugal chamber assembly 101 further includes a protective cover 101g, which is fixed in position and located above the centrifugal chamber 101b to prevent users from accidentally touching the rotating centrifugal chamber 101b. The joint fixing member 101e is mounted on the top of the protective cover 101g to be motionless. When the sample sorting structure is applied to the sorting device 1000, as shown in FIG. 16, the protective cover 101g is mounted on the base frame 200.

Further, the protective cover 101g is made of transparent material to facilitate observation of the interior of the centrifugal chamber 101b.

For easy removal or placement of the protective cover 101g, a handle 101g-1 is provided on the top of the protective cover 101g.

To facilitate the connection between the centrifugal chamber assembly 101 and the spindle 103, the centrifugal chamber assembly 101 further includes a shaft sleeve 101c, which is mounted to the centrifugal chamber 101b. Specifically, a receiving through-hole for accommodating the shaft sleeve 101c is provided at the bottom of the centrifugal chamber housing 101b-1, and a top end of the shaft sleeve 101c is inserted into the receiving through-hole. A limiting step 101c-1 is provided near the top end of the shaft sleeve 101c, with the top of the limiting step 101c-1 being in limiting contact with the bottom of the centrifugal chamber housing 101b-1.

The rotation driving assembly 102 is in transmission connection with the shaft sleeve 101c, and the spindle 103 is provided in the shaft sleeve 101c, with its top end extending out of the shaft sleeve 101c and entering the centrifugal inner cavity 101a, and its bottom end extending out of the shaft sleeve 101c and being in transmission connection with the translation driving assembly 105.

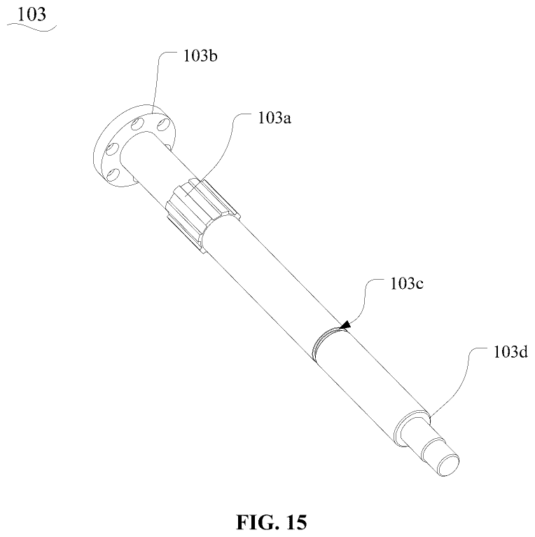

As shown in FIG. 15, splines 103a are provided on an outer wall of the spindle 103, and splines 103a are provided on an inner wall of the shaft sleeve 101c to cooperate with the splines 103a of the spindle 103. Alternatively, a key may be used instead of the splines 103a. Any transmission manner which can not only achieve transmission of torque but also allow the spindle 103 to slide relative to the shaft sleeve 101c falls within the protection scope of the present application.

In some embodiments, the rotation driving assembly 102 includes a first mounting seat 102a, a bearing seat 102b, a bearing set 102c, a first driver 102d, and a first transmission mechanism 102e.

The first mounting seat 102a is fixed in position, and may be mounted on the base frame of the system to be used or directly fixed on the ground, for example.

A mounting hole for passage of the shaft sleeve 101c is provided in the first mounting seat 102a, with a certain gap between the outer wall of the shaft sleeve 101c and an inner wall of the mounting hole.

The bearing seat 102b is mounted on the first mounting seat 102a. Specifically, the bearing seat 102b is detachably mounted on the top of the first mounting seat 102a by bolts or other fasteners.

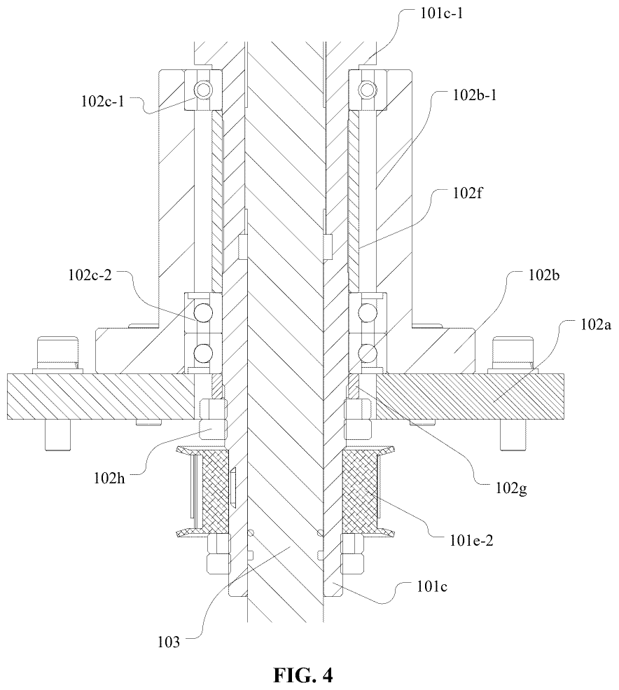

The bearing set 102c is mounted in the bearing seat 102b. As shown in FIGS. 3 and 4, the bearing set 102c includes a first bearing 102c-1 and a second bearing 102c-2, which are respectively mounted at both ends of the inner cavity of the bearing seat 102b. For example, the number of the first bearing 102c-1 may be one and the number of the second bearing 102c-2 may be two, that is, the second bearings 102c-2 may be angular contact ball bearings mounted in pair.

The rotation driving assembly 102 further includes a first spacer 102f, a second spacer 102g, and a locking member 102h.

The end of an inner ring of the first bearing 102c-1 facing the centrifugal chamber 101b abuts against the bottom of the first limiting step 101c-1. The first spacer 102f is provided outside the shaft sleeve 101c, and the end of the first spacer 102f facing the centrifugal chamber 101b abuts against the end of the inner ring of the first bearing 102c-1 facing away from the centrifugal chamber 101b.

A limiting protrusion 102b-1 is provided on an inner wall of the bearing seat 102b, and the end of the outer ring of the first bearing 102c-1 facing away from the centrifugal chamber 101b abuts against the end of the limiting protrusion 102b-1 facing the centrifugal chamber 101b.

The end of an inner ring of the second bearing 102c-2 facing the centrifugal chamber 101b abuts against the end of the first spacer 102f facing away from the centrifugal chamber 101b, and the end of the outer ring of the second bearing 102c-2 facing the centrifugal chamber 101b abuts against the end of the limiting protrusion 102b-1 facing away from the centrifugal chamber 101b. It should be noted that a length of the first spacer 102f is equal to a length of the limiting protrusion 102b-1.

The second spacer 102g is provided around the shaft sleeve 101c, and the end of the second spacer 102g facing the centrifugal chamber 101b abuts against the end of the inner ring of the second bearing 102c-2 facing away from the centrifugal chamber 101b. The locking member 102h is locked onto the shaft sleeve 101c, and the end of the locking member 102h facing the centrifugal chamber 101b abuts against the end of the second spacer 102g facing away from the centrifugal chamber 101b.

That is to say, the bearing set 102c is fixed and positioned by the bearing seat 102b, the shaft sleeve 101c, the first spacer 102f, and the second spacer 102g, facilitating stable centrifugation operation.

It should be noted that the locking member 102h may be in any structure that realizes the locking of the second spacer 102g. For example, the locking member 102h may be a locking nut.

The first driver 102d is mounted on the first mounting seat 102a and is in transmission connection with the shaft sleeve 101c through the first transmission mechanism 102e.

Specifically, the first driver 102d is a first motor, which directly provides power to the first transmission mechanism 102e. Alternatively, the first driver 102d may include a first motor and a first speed reducer in transmission connection with the first motor, so that, after speed reduction achieved by the first speed reducer, the power provided by the first motor is transmitted to the first transmission mechanism 102e.

Further, as disclosed in the present application, the first transmission mechanism 102e is a belt drive mechanism, which includes a driving pulley 101e-1, a driven pulley 101e-2, and a driving belt 101e-3. For example, if the first driver 102d is the first motor, the driving pulley 101e-1 is mounted on an output shaft of the first motor, and the driven pulley 101e-2 is mounted around the shaft sleeve 101c, and the driving belt 101e-3 is in transmission connection with both the driving pulley 101e-1 and the driven pulley 101e-2. Specifically, a shoulder for limiting a top end of the driven pulley 101e-2 is provided on the shaft sleeve 101c, and a bottom end of the driven pulley 101e-2 is locked onto the shaft sleeve 101c with a nut.

It should be noted that the first transmission mechanism 102e may be configured as any other mechanism, e.g., a transmission gear mechanism which achieves transmission through gears, or a conveyor chain mechanism which achieves transmission through a conveyor chain.

As shown in FIG. 2, the first transmission mechanism 102e and the bearing seat 102b are respectively mounted at both sides of the first mounting seat 102a.

In some embodiments, the translation driving assembly 105 includes a second mounting seat 105a, a second driver 105b, and a second transmission mechanism 105c.

The second mounting seat 105a is fixed, and may be mounted on the base of the system to be used or directly fixed on the ground, for example.

The second driver 105b is mounted on the second mounting seat 105a. Specifically, the second driver 105b includes a second motor 105b-1, a transmission shaft 105b-2, and a fourth bearing 105b-3. The second motor 105b-1 is mounted on the second mounting seat 105a and is in transmission connection with the transmission shaft 105b-2. The transmission shaft 105b-2 is rotatably mounted on the second mounting seat 105a through a pedestal-mounted fourth bearing 105b-3.

To adjust the rotational speed output by the second motor 105b-1, a second speed reducer 105b-5 may further be provided between the second motor 105b-1 and the transmission shaft 105b-2.

One end of the second transmission mechanism 105c is in transmission connection with the transmission shaft 105b-2, and the other end of the second transmission mechanism 105c is in transmission connection with the end of the spindle 103 away from the centrifugal chamber assembly 101. The second transmission mechanism 105c is driven by the second driver 105b to move the spindle 103 in the centrifugal inner cavity 101a.

It should be noted that the specific structure of the translation driving assembly 105 disclosed above is only embodied in one specific embodiment of the present application. In practical applications, the translation driving assembly 105 may be configured to include a second mounting seat 105a, and a linear electric cylinder, a pneumatic cylinder, a hydraulic cylinder, or an electric push rod mounted on the second mounting seat 105a, which has a driving end rotatably connected to the spindle 103.

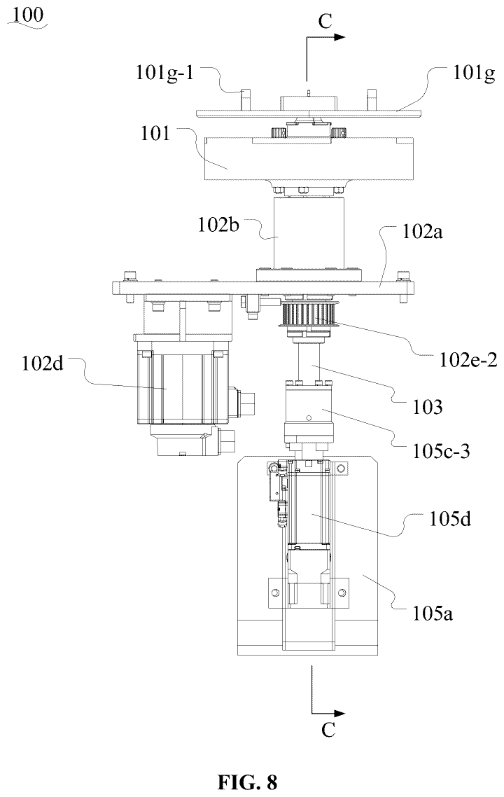

In some embodiments, as shown in FIGS. 8 and 9, the translation driving assembly 105 includes a second mounting seat 105a and a linear electric cylinder 105d mounted on the second mounting seat 105a, for example. In this case, the linear electric cylinder 105d has an extending shaft which is driven by a motor through a speed reducer and a ball screw driven by the speed reducer to move axially, and the extending shaft is structured to be movable axially but not rotatable.

As shown in FIGS. 2 and 3, the second transmission mechanism 105c is a rocker sliding mechanism, which includes a rocker arm 105c-1, a connecting rod 105c-2, a bearing chamber 105c-3, and a third bearing 105c-4. One end of the rocker arm 105c-1 is fixed to the transmission shaft 105b-2 to achieve a transmission connection with the second driver 105b.

The other end of the rocker arm 105c-1 is hinged to one end of the connecting rod 105c-2, and the other end of the connecting rod 105c-2 is hinged to the bearing chamber 105c-3. The third bearing 105c-4 is mounted in the bearing chamber 105c-3, and one end of the spindle 103, which is away from the centrifugal chamber assembly 101, is rotatably connected to the third bearing 105c-4. The rotation axis of the rocker arm 105c-1 is perpendicular to the direction in which the spindle 103 moves in the centrifugal inner cavity 101a, as shown in FIG. 3.

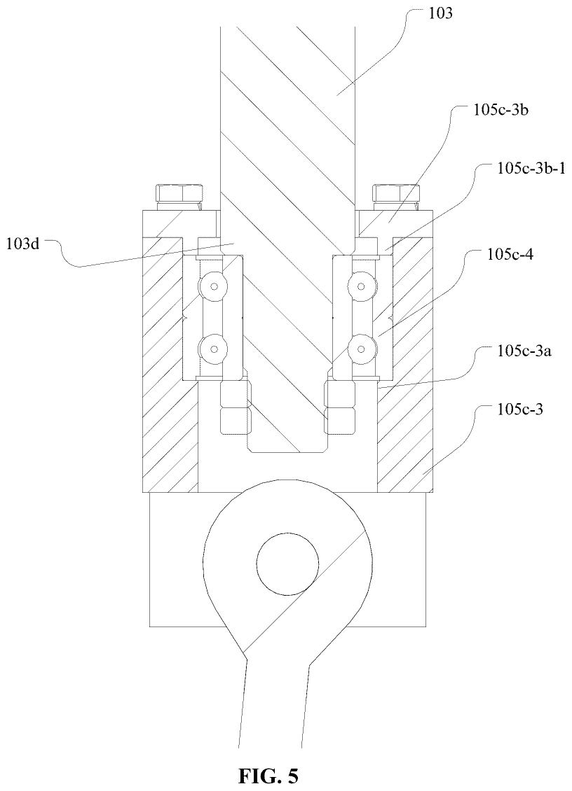

Specifically, as shown in FIG. 5, a first limiting boss 105c-3a is provided on an inner wall of the bearing chamber 105c-3 near its bottom end. The outer ring of the third bearing 105c-4 is arranged in the bearing chamber 105c-3, with the bottom end of the outer ring of the third bearing 105c-4 abutting against the first limiting boss 105c-3a. The inner ring of the third bearing 105c-4 is arranged outside the spindle 103, with the bottom end of the inner ring of the third bearing 105c-4 abutting against a nut mounted at the bottom end of the spindle 103. The spindle 103 is provided with a second limiting boss 103d to abut against the top end of the inner ring of the third bearing 105c-4. A bearing chamber cover 105c-3b is provided and covers on the top end of the bearing chamber 105c-3, and an escape hole is provided in the bearing chamber cover 105c-3b to allow the spindle 103 to pass through. A limiting ring 105c-3b-1 extending towards the inner cavity of the bearing chamber 105c-3 is provided on the end of the bearing chamber cover 105c-3b facing the bearing chamber 105c-3, and the limiting ring 105c-3b-1 abuts against the top end of the outer ring of the third bearing 105c-4.

It should be noted that the second transmission mechanism 105c being a rocker sliding mechanism is only embodied in a specific embodiment of the present application. In practical applications, the second transmission mechanism 105c may be configured as a screw-and-nut mechanism, with the spindle 103 being rotatably connected to the nut of the screw-and-nut mechanism.

To adapt to the distance between the rocker arm 105c-1 and the bearing chamber 105c-3, the rocker sliding mechanism further includes a first joint bearing 105c-5 and a second joint bearing 105c-6.

One end of the first joint bearing 105c-5 is threadedly connected to one end of the connecting rod 105c-2, and the other end of the first joint bearing 105c-5 is hinged to the bearing seat 102b of the third bearing 105c-4. One end of the second joint bearing 105c-6 is threadedly connected to the other end of the connecting rod 105c-2, and the other end of the second joint bearing 105c-6 is hinged to the rocker arm 105c-1. Specifically, one of the first joint bearing 105c-5 and the second joint bearing 105c-6 is a right-hand thread joint bearing, and the other is a left-hand thread joint bearing.

To avoid excessive displacement of the spindle 103 in the centrifugal inner cavity 101a to cause collision with the centrifugal inner cavity 101a, the translation driving assembly 105 further includes a limiting sensor 105b-4. The limiting sensor 105b-4 is mounted on the second mounting seat 105a to detect the rotation angle of the transmission shaft 105b-2. Specifically, the limiting sensor 105b-4 may be multiple photoelectric sensors to mark the rotation angle of the transmission shaft 105b-2, or may be an encoder to feedback the rotation angle of the transmission shaft 105b-2.

To further control the displacement of the spindle 103, as disclosed in the present application, a detection groove 103c is provided on the spindle 103. A position sensor is mounted at the bottom end of the shaft sleeve 101c, with the detection groove 103c being located above the position sensor. When the detection groove 103c moves to a position aligned with the position sensor, the position sensor triggers an alarm connected to it.

In a second aspect, as shown in FIG. 16, a sorting device 1000 is provided according to the present application. Specifically, the sorting device 1000 includes a base frame 200, a control device 300, and the sample sorting structure 100 as described in any one of the above embodiments.

The sample sorting structure 100 and the control device 300 are both mounted on the base frame 200, and the control device 300 is in signal connection with the sample sorting structure 100 to control the operation of the sample sorting structure 100.

Specifically, as shown in FIG. 10, the control device 300 includes a controller and a touch screen in signal connection with the controller. The controller controls the operation of various parts of the sorting device 1000, and the touch screen can promptly display the operating status of various parts of the sorting device 1000 and facilitate human-computer interaction.

To facilitate the mounting of various parts of the sorting device 1000, as disclosed in the present application, the base frame 200 includes a frame body 201 and a mounting panel 202 mounted on a top of the frame body 201. The mounting panel 202 is arranged on one side of the top of the frame body 201 and is used for mounting pipelines, and the frame body 201 is used for mounting the sample sorting structure 100.

In a third aspect, a sample sorting method is provided according to the present application, including the following steps:

providing a sample sorting structure 100 as described in any one of the above embodiments;

placing a sample bag to be sorted on the pressing platform 104 in the centrifugal inner cavity 101a;

activating the rotation driving assembly 102 to drive the centrifugal chamber assembly 101 and the spindle 103 to rotate synchronously, thereby driving the sample bag to be sorted to rotate for sample stratification; and

activating the translation driving assembly 105 to move the spindle 103 towards one side of the centrifugation inner cavity 101a for pressing the sample bag to be sorted, thereby pressing the sample bag to be sorted to squeeze the stratified samples therein into corresponding containers.

In the present application, it is possible to squeeze different sample layers in the sample bag to be sorted into corresponding containers, thereby achieving sample sorting. The present application adopts an automatic sorting method, which improves the efficiency of sample sorting and reduces labor costs.

In a fourth aspect, a sample sorting fluid system is provided according to the present application, including an output pipeline, sorting containers, and the sample sorting structure 100 as described in any one of the above embodiments.

The outlet of the sample bag to be sorted in the sample sorting structure 100 is connected to an inlet of the output pipeline through a rotary joint, and the outlets of the output pipeline are respectively connected to the corresponding sorting containers.

Since the sample sorting fluid system provided by the present application includes the sample sorting structure 100 in any one of the above embodiments, all the beneficial effects of the sample sorting structure 100 are also applied to the sample sorting fluid system provided by the present application.

In a fifth aspect, a sample cultivation system is provided according to the present application, including an output pipeline, sample cultivation vessels, and the sample sorting structure 100 as described in any one of the above embodiments.

The outlet of the sample bag to be sorted in the sample sorting structure 100 is connected to the inlet of the output pipeline through a rotary joint, and the outlets of the output pipeline are respectively connected to the corresponding sample cultivation vessels.

Since the sample cultivation system provided by the present application includes the sample sorting structure 100 in any one of the above embodiments, all the beneficial effects of the sample sorting structure 100 are also applied to the sample cultivation system provided by the present application.

It should be noted that for easy of description, the drawings merely show the related parts of the present application. In a case of no conflict, the embodiments of the present application and features in the embodiments may be combined with each other.

It should be understood that “system”, “device”, “unit” and/or “module” in the present application are used for distinguishing different components, elements, parts, portions or assemblies at different levels. However, if other expressions can realize the same purpose, they may be replaced by other expressions.

As shown in the present application and claims, unless the context clearly indicates an exception, the words such as “one”, “a”, “an” and/or “the” do not specifically refer to the singular, but may also include the plural. Generally speaking, the terms “include” and “comprise” only indicate the inclusion of clearly identified steps and elements, and these steps and elements do not constitute an exclusive list, and a method or device may also include other steps or elements. The elements limited by the statement “comprising (including) a . . . ” do not exclude the existence of other identical elements exist in the process, method, product or apparatus that includes the elements.

In the description of the embodiments of the present application, unless otherwise specified, “/” means or, for example, A/B can mean A or B. The “and/or” herein is only an association relationship that describes the associated objects, which means that there may be three kinds of relationships, for example, A and/or B may mean that there are three cases: A alone, A and B at the same time, and B alone. In addition, in the description of the embodiments of the present application, “multiple” refers to two or more.

Hereinafter, the terms “first” and “second” are only used for descriptive purposes, and cannot be understood as indicating or implying relative importance or implicitly indicating the number of indicated technical features. Therefore, a feature defined by “first” or “second” may explicitly or implicitly includes one or more of the features.

A flowchart is used in the present application to explain the operation performed by the system according to the embodiment of the present application. It should be understood that the preceding or subsequent operations are not necessarily performed accurately in sequence. Instead, the steps can be processed in reverse order or simultaneously. In addition, other operations can be added to these procedures, or one or more operations can be removed from these procedures.

The above description illustrates only preferable embodiments of the present application and an illustration of the technical principles applied, which are not intended to limit the present application. Various changes and variations may be made by those skilled in the art to the present application. The scope of the present application is not limited to the technical solutions formed by a particular combination of the above technical features, but also covers other technical solutions formed by any combination of the above technical features or their equivalent features without departing from the above application concept. For example, the scope of the present application may cover a technical solution formed by replacing the features described above with technical features with similar functions disclosed in (but not limited to) the present application.

1. A sample sorting structure comprising:
a centrifugal chamber assembly having a centrifugal inner cavity;
a rotation driving assembly for driving the centrifugal chamber assembly to rotate;
a spindle connected to the centrifugal chamber assembly in such a manner as to rotate synchronously, wherein one end of the spindle extends into the centrifugal inner cavity and is movable relative to the centrifugal inner cavity;
a pressing platform fixed at the end of the spindle extending into the centrifugal inner cavity, wherein the pressing platform is configured to load a sample bag to be sorted and be moved by the spindle towards or away from a side of the centrifugal inner cavity for pressing the sample bag to be sorted; and
a translation driving assembly for driving the spindle to move in the centrifugal inner cavity, wherein the translation driving assembly is rotatably connected to the spindle.

2. The sample sorting structure according to claim 1, wherein the side of the centrifugal inner cavity for pressing the sample bag to be sorted is arranged in parallel to a side of the pressing platform for loading the sample bag to be sorted.

3. The sample sorting structure according to claim 2, wherein the centrifugal chamber assembly comprises:
a centrifugal chamber, wherein an inner cavity of the centrifugal chamber is the centrifugal inner cavity; and
a shaft sleeve mounted to the centrifugal chamber, wherein the rotation driving assembly is in transmission connection with the shaft sleeve; the spindle is disposed in the shaft sleeve and has one end extending out of the shaft sleeve and entering the centrifugal inner cavity, and the other end extending out of the shaft sleeve and being in transmission connection with the translation driving assembly.

4. (canceled)

5. The sample sorting structure according to claim 3, wherein the centrifugal chamber comprises a centrifugal chamber housing and a centrifugal chamber cover;
the centrifugal chamber housing has an opening at an end, and the centrifugal chamber cover is detachably provided at and covers the opening of the centrifugal chamber housing; and
the shaft sleeve is fixed to the end of the centrifugal chamber housing opposite to the opening.

6. The sample sorting structure according to claim 5, wherein:
a rotation-limiting projection is provided on an edge of the centrifugal chamber cover, and a rotation-limiting notch is provided on a top end of the centrifugal chamber housing and configured to limit the rotation-limiting projection; and/or
the centrifugal chamber cover and the centrifugal chamber housing have surfaces facing each other, one of the surfaces is provided with a connecting column, the connecting column is provided with a fastening hole on an end surface facing the other of the surfaces, the other of the surfaces is detachably connected to the connecting column through a fastener, and a through hole is provided in the pressing platform to allow passage of the connecting column; or
the centrifugal chamber cover and the centrifugal chamber housing are each provided with a connecting hole, and detachably connected to each other by a fastener, and a through hole is provided in the pressing platform to allow passage of the fastener.

7. The sample sorting structure according to claim 5, wherein:
the centrifugal chamber assembly further comprises a rotary joint, which is mounted on the centrifugal chamber cover; and
the rotary joint has one end connected to an outlet of the sample bag to be sorted and the other end externally connected to an output pipeline.

8. The sample sorting structure according to claim 7, wherein:
the centrifugal chamber assembly further comprises a joint fixing member and a centrifuge rubber block;
the centrifuge rubber block is inserted into a rubber-block fixing through-hole provided in the centrifugal chamber cover, and the centrifuge rubber block is provided with a mounting hole for mounting one end of the rotary joint connected to the sample bag to be sorted in the centrifugal chamber; and
the joint fixing member is fixed, and the other end of the rotary joint is mounted to the joint fixing member and extends out of the joint fixing member to be externally connected to the output pipeline.

9.-10. (canceled)

11. The sample sorting structure according to claim 1, wherein:
at least part of a cross section of the pressing platform gradually decreases in a direction from an end face of the pressing platform facing away from the spindle to an end face of the pressing platform facing the spindle; or
the pressing platform comprises a first turntable for supporting the sample bag to be sorted and a second turntable connected to the spindle, wherein the second turntable is connected to a bottom of the first turntable, and reinforcement ribs are provided between the first turntable and the second turntable; and/or
the spindle is provided with a connecting disc connected to the pressing platform.

12. The sample sorting structure according to claim 3, wherein the rotation driving assembly comprises:
a first mounting seat provided with a mounting hole for allowing passage of the shaft sleeve;
a bearing seat mounted on the first mounting seat;
a bearing set mounted in the bearing seat, with the shaft sleeve being disposed in the bearing set;
a first driver mounted on the first mounting seat; and
a first transmission mechanism in transmission connection with the first driver and the shaft sleeve.

13. The sample sorting structure according to claim 9, wherein:
the first driver is a first motor, or the first driver comprises a first motor and a first speed reducer in transmission connection with the first motor; and/or
the first transmission mechanism is a transmission belt mechanism, a transmission gear mechanism or a conveyor chain mechanism; and/or
the first transmission mechanism and the bearing seat are respectively mounted at two sides of the first mounting seat.

14. The sample sorting structure according to claim 13, wherein:
the rotation driving assembly further comprises a first spacer, a second spacer, and a locking member;
the bearing set comprises a first bearing and a second bearing;
an outer wall of the shaft sleeve is provided with a first limiting step, an end of an inner ring of the first bearing facing the centrifugal chamber abuts against the first limiting step, and the first spacer is arranged outside the shaft sleeve, and an end of the first spacer facing the centrifugal chamber abuts against an end of the inner ring of the first bearing facing away from the centrifugal chamber;
an inner wall of the bearing seat is provided with a limiting protrusion, and an end of an outer ring of the first bearing facing away from the centrifugal chamber abuts against an end of the limiting protrusion facing the centrifugal chamber;
an end of an inner ring of the second bearing facing the centrifugal chamber abuts against an end of the first spacer facing away from the centrifugal chamber, an end of an outer ring of the second bearing facing the centrifugal chamber abuts against an end of the limiting protrusion facing away from the centrifugal chamber, the second spacer is arranged outside the shaft sleeve, an end of the second spacer facing the centrifugal chamber abuts against an end of the inner ring of the second bearing facing away from the centrifugal chamber, the locking member is locked onto the shaft sleeve, and an end of the locking member facing the centrifugal chamber abuts against an end of the second spacer facing away from the centrifugal chamber.

15. The sample sorting structure according to claim 1, wherein:
the translation driving assembly comprises:
a second mounting seat;
a second driver mounted on the second mounting seat; and
a second transmission mechanism which has one end in transmission connection with the second driver, and the other end in transmission connection with an end of the spindle away from the centrifugal chamber assembly, so as to be driven by the second driver and move the spindle in the centrifugal inner cavity; or
the translation driving assembly comprises:
a second mounting seat; and
a linear electric cylinder, a pneumatic cylinder, a hydraulic cylinder, or an electric push rod mounted on the second mounting seat and having a driving end rotatably connected to the spindle.

16. The sample sorting structure according to claim 15, wherein:
the second transmission mechanism is a rocker slider mechanism, which comprises:
a rocker arm, a connecting rod, a bearing chamber, and a third bearing,
one end of the rocker arm is in transmission connection with the second driver, the other end of the rocker arm is hinged to one end of the connecting rod, the other end of the connecting rod is hinged to the bearing chamber, the third bearing is mounted in the bearing chamber, and the end of the spindle away from the centrifugal chamber assembly is rotatably connected to the third bearing,
a rotation axis of the rocker arm is perpendicular to a direction of movement of the spindle in the centrifugal inner cavity;
or
wherein the second transmission mechanism is a screw-and-nut mechanism, and the spindle is rotatably connected to a nut of the screw-and-nut mechanism.

17. The sample sorting structure according to claim 16, wherein:
the rocker sliding mechanism further comprises a first joint bearing and a second joint bearing;
one end of the first joint bearing is threadedly connected to one end of the connecting rod, and the other end of the first joint bearing is hinged to the second bearing seat; and
one end of the second joint bearing is threadedly connected to the other end of the connecting rod, and the other end of the second joint bearing is hinged to the rocker arm.

18. The sample sorting structure according to claim 16, wherein:
the second driver comprises a second motor, a transmission shaft, and a fourth bearing; and
the second motor is mounted on the second mounting seat and is in transmission connection with the transmission shaft, the transmission shaft is rotatably mounted on the second mounting seat through the fourth bearing, and the rocker arm is fixed on the transmission shaft.

19. The sample sorting structure according to claim 18, wherein:
the translation driving assembly further comprises a limiting sensor; and
the limiting sensor is mounted on the second mounting seat and configured to detect a rotation angle of the transmission shaft.

20. A sorting device comprising a base frame, a control device, and the sample sorting structure according to claim 1, wherein:
the sample sorting structure and the control device are both mounted on the base frame, and the control device is in signal connection with the sample sorting structure.

21. A sample sorting fluid system, comprising an output pipeline, sorting containers, and the sorting device according to claim 20, wherein:
an outlet of a sample bag to be sorted within the sample sorting structure is connected to an inlet of the output pipeline through a rotary joint, and outlets of the output pipeline are respectively connected to the corresponding sorting containers.

22. A sample cultivation system, comprising an output pipeline, sample cultivation vessels, and the sample sorting structure according to claim 1, wherein:
an outlet of a sample bag to be sorted within the sample sorting structure is connected to an inlet of the output pipeline through a rotary joint, and outlets of the output pipeline are respectively connected to the corresponding sample cultivation vessels.

23. A sample sorting method, comprising:
providing the sample sorting structure according to claim 1;
placing a sample bag to be sorted on the squeezing platform in the centrifugal inner cavity;
activating the rotation driving assembly to drive the centrifugal chamber assembly and the spindle to rotate synchronously, so as to rotate the sample bag to be sorted for sample stratification; and
activating the translation driving assembly to drive the spindle to move towards a side of the centrifugal inner cavity for pressing the sample bag to be sorted, so as to press the sample bag to be sorted to squeeze the stratified samples therein into corresponding containers.
